(19) United States
(12) Patent Application Publication
(10) Pub. No.: US 2011/0087786 A1
(43) Pub. Date: Apr. 14, 2011

(54) METHOD AND APPARATUS FOR EFFICIENT RESOURCE ALLOCATION OF QUALITY OF SERVICE PROFILES IN MOBILE NETWORKS

(75) Inventors: Santosh Chandrachood, Milpitas, CA (US); Hei Tao Fung, Freemont, CA (US)

(73) Assignee: WiChorus, Inc., Naperville, IL (US)

(21) Appl. No.: 12/900,324

(22) Filed: Oct. 7, 2010

Related U.S. Application Data
(60) Provisional application No. 61/278,505, filed on Oct. 7, 2009.

(51) Int. Cl. G06F 15/173

(52) U.S. Cl. 709/226

(57) ABSTRACT

Current subscriber-aware networks provision individual subscriber parameters in a centrally located repository and return the parameters to entities for quality of service (QoS) enforcement on a per-subscriber basis. In other words, there is a one-to-one mapping of each QoS profile for each subscriber. Attaching QoS profiles to each subscriber can result in very high resource requirements, such as a larger memory footprint or multiple policing profiles, resulting in a non-scalable network resource. To resolve resource explosion problem without sacrificing functional requirements, an example embodiment of the present invention allows few service classes with QoS parameters to exist and derives various subscriber plans out of them. The example embodiment is useful to generate subscriber plans dynamically as subscribers join network and thereby helps to reduce QoS resource requirements dramatically, without sacrificing any functional capability.

### RELATED APPLICATION

This application claims the benefit of U.S. Provisional Application No. 61/278,505, filed on Oct. 7, 2009, the entire teachings of which are incorporated herein by reference.

### BACKGROUND OF THE INVENTION

In subscriber aware networks, such as Worldwide Interoperability for Microwave Access (WiMax) networks, High Speed Packet Access (HSPA) networks, 3^{rd} Generation Partnership Project Long Term Evolution (3GPP LTE) networks etc., quality of service (QoS) parameters are tightly associated with each subscriber. Due to network resource constraints such as radio bandwidth, QoS is enforced end-to-end on per subscriber basis.

### SUMMARY OF THE INVENTION

Embodiments of the present invention include methods, apparatuses, and computer program products for enforcing service profiles in a mobile network. An example embodiment of the present invention includes a network node in a mobile network that includes modules configured to enforce service profiles. Modules are configured to compare service profiles based on service parameters and define service-profile identifiers with service profile having common service parameters. Further, the modules can group subscriber identifiers with the service-profile identifiers based on the service profiles and enforce the service profiles for each subscriber identifier.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of a network illustrating aspects of an example embodiment of the invention.

FIG. 2 is a block diagram of an embodiment of the invention illustrating interconnected functional elements.

FIG. 3A is a flow chart of an embodiment of the present invention illustrating functions involved in enforcing service profiles.

FIG. 3B is a flow diagram of an embodiment of the present invention illustrating a method of enforcing service profiles.

FIG. 3C is a block diagram of an embodiment of the invention illustrating components involved in enforcing service profiles.

FIG. 4 is a flow chart of an embodiment of the invention illustrating a method of mapping quality of service profiles in an enforcement device.

FIG. 5 is a logical diagram of an embodiment of the present invention illustrating a memory.

### DETAILED DESCRIPTION OF THE INVENTION

A description of example embodiments of the invention follows.

In current subscriber-aware mobile networks, parameters of each subscriber are provisioned in a centrally located repository, such as an authentication, authorization, and accounting (AAA) server or home location register (HLR). These parameters are returned to entities enforcing quality of service (QoS) on a per-subscriber basis, which limits the number of subscribers that can be supported.

Previous approaches attempt a solution with infinite resources that can copy each QoS profile on per-subscriber basis and can have one-to-one mapping in software, as well as hardware. The previous attempts at solutions placed severe limitations on the number of subscribers that can be supported by a network. Other attempts to solve this problem tried to share common parameters, such as classifiers, in a scarce resource such as a ternary content addressable memory (TCAM), such that packets matching a set of classifiers can be mapped to one QoS class even though packets may arrive from two different subscribers. Previous approaches in the industry program a TCAM with classifier for each subscriber (with each subscriber's Internet protocol (IP) address), causing the scarce resource memory of the data plane to be quickly exhausted. Furthermore, prior approaches cannot support overlapping classifiers.

Example embodiments of the present invention allow a profile identifier to be associated to a given set of subscribers first, and classifiers for that profile identifier are programmed. Each profile identifier creates a unique (disjoint) set of classifiers that can be matched in parallel in the TCAM. Following receipt of a traffic packet, the forwarding engine can perform a look-up of the profile and use it to form a TCAM key. Based on the TCAM key, the TCAM can look-up only the classifiers that are needed. This provides the service class within a given profile. A look-up of classifiers using a subscriber identifier, which can include, for example, an IP address, international mobile subscriber identity (IMSI), or other known or future-developed identifier, can map the subscriber identifier to a unique QoS profile in hardware; thereby reducing QoS resource requirements without sacrificing functional capability.

In the example embodiment, a system-wide profile identifier is assigned to a plan; all subsequent subscribers with that plan can be mapped, at an enforcement device such as an Access Signaling Node Gateway (ASN-GN), Gateway GPRS Support Node (GGSN), or a network processing unit (NPU), with that system-wide profile identifier. For example, if a service provider has ten service plans and one million subscribers using those ten service plans, then a memory in a control plane of the example embodiment is only consumed for the ten plans. In alternative embodiments, data corresponding to the ten service plans are maintained strictly in the data plane, offloading more data and processing from this control plane. Details of which are described in Applicants' pending U.S. patent application (Serial Number not yet assigned) being filed concurrently herewith, entitled “Method and Apparatus for Assigning Resources in a Network Node” by Santosh Chandrachood, which claims priority to Applicants' U.S. Provisional Patent Application No. 61/278,486, filed Oct. 7, 2009, entitled “A Method and Apparatus to Allocate Network Processing Unit Resources Dynamically in Fast Path Without Host CPU Involvement and Without Statically Holding Up Resources” by Chandrachood, the entire teachings of both applications being incorporated herein by reference in their entirety.

Embodiments of the present invention can account for a fact that a network operator may create a few service classes with QoS parameters and derive various subscriber plans out of service classes. For example, a service provider can have voice1, voice2, voice3, video1, video2, video3, BE1, BE2, BE3 service classes but may create plans such as Gold'{voice1, video1, BE1} and so on. Embodiments of the present invention may enable plans to be generated in a dynamic manner as subscribers join the network.

Embodiments of the present invention provide various technical advantages over conventional methods and apparatuses for allocating resource in a network node, such as scaling network resources to handle large numbers of classifiers by “chunking” classifiers together dynamically without truncation. Some of these technical advantages are shown and described with respect to the accompanying figures. Certain embodiments of the present invention may enjoy some, all, or none of these advantages. Other technical advantages should be readily apparent to those skilled in the art from the following figures, description, and claims.

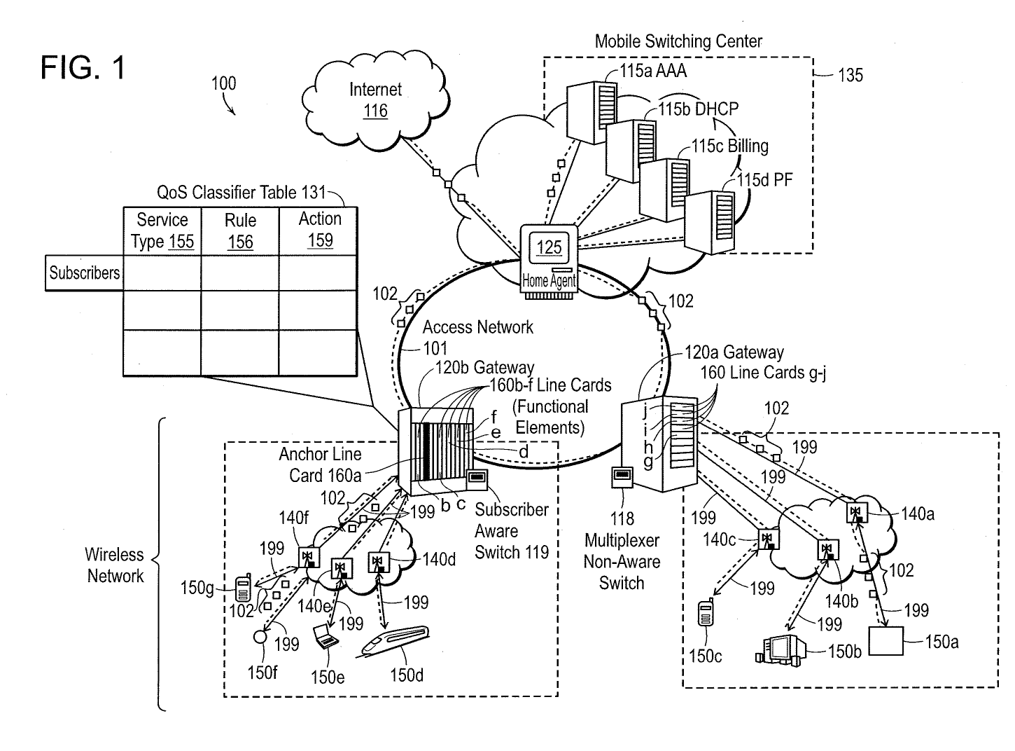

FIG. 1 is a network diagram of a network 100 illustrating aspects of an example embodiment of the invention. The network 100 can be any type of network with wireless access, such as a wide area network (WAN) having wireless access thereto, wireless broadband network employing a Worldwide Interoperability for Microwave Access (WiMax) network, High Speed Packet Access (HSPA) network, 3^{rd} or 4^{th} Generation Partnership Project Long Term Evolution (3GPP LTE) network, or other commonly employed or hereafter-developed network. The network 100 can include at least one access network 101 to interconnect operably with a number of network elements, which may include, for example, mobile end user devices (hereinafter “mobile devices”) 150a-g.

The access network 101 can connect basic network elements such as a mobility management entity (MME) (not shown), home location register (HLR) (not shown), home agent 125, gateways 120a-b, or other known network elements. The access network 101 connects to at least one base station 140a-f, either directly or through additional networks, such as an edge network (not shown), which connect mobile devices 150a-g via a telecommunications interface or wireless medium, e.g., an air interface. The home agent 125 further connects the wireless network to external networks, e.g., the Internet 116 or a mobile switching center containing service portals 115a-d. The service portals 115a-d can include a multitude of service types, for example, an authentication, authorization, and accounting (AAA) server 115a, dynamic host configuration protocol (DHCP) server 115b, billing server 115c, home policy function (PF) server 115d, or other type of portal that may be used at the mobile switching center. The AAA server 115a may provide authentication services to validate a subscriber, authorization to determine the subscriber's rights, and accounting to determine subscriber's usage. The DHCP server 115b may provide for address allocation services in a manual, automatic, or dynamic manner, or as otherwise provided by a network administrator. The PF server 115d may provide general policy rules or application dependent policy rules. The PF server 115d may evaluate network requests against the policies and may be associated with a home policy database, which may be associated with a network service processor (NSP) (not shown).

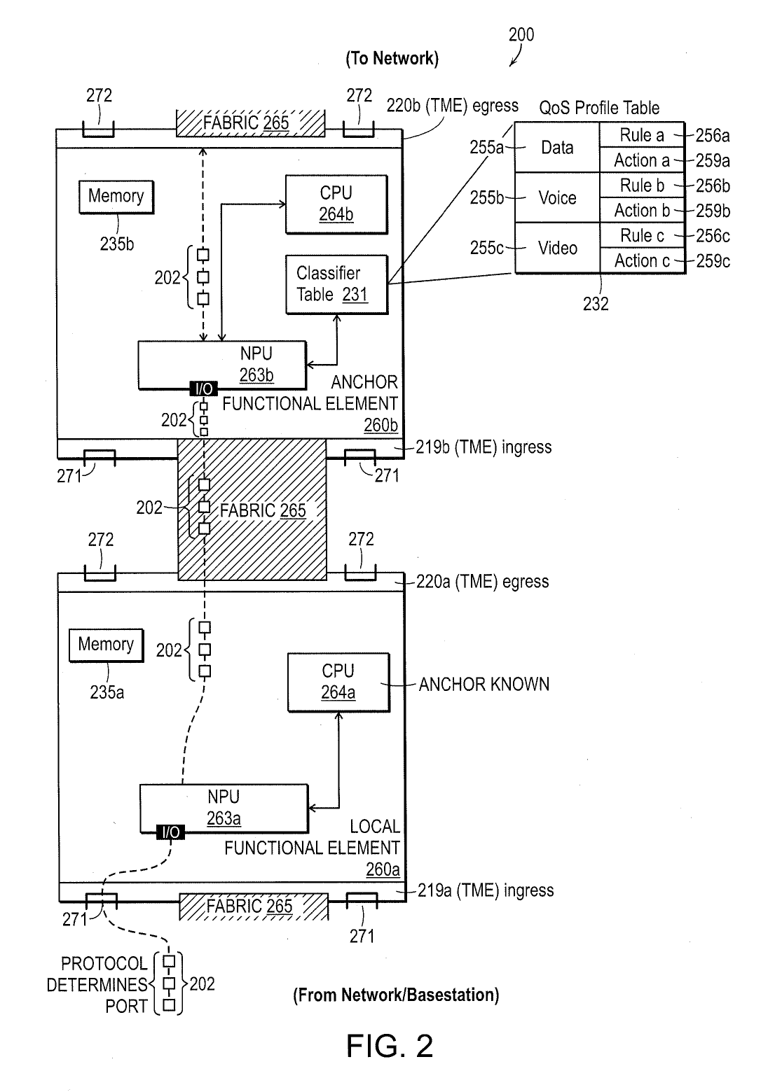

For example, continuing to refer to FIG. 1, the traffic 102, originating at a mobile device, such as mobile device 150b, may travel upstream toward the base station 140b via wireless medium 199, which, in turn, may forward the traffic 102 to the gateway 120a via the wireless medium 199. The gateway 120a can be any of a multitude of wireless gateways, may include, for example, an Access Signaling Node Gateway (ASN-GN), Gateway GPRS Support Node (GGSN), Serving General Packet Radio Service Support Node (SGSN), System Architecture Evolution (SAE) gateway, or other currently known or hereafter-developed gateway. In the example network 100, the gateway 120a may contain at least one functional element, or multiple functional elements in a chassis 160a-f; the functional elements can be, for example, a line card. The functional element 160a (described in more detail below in reference to FIG. 2) receives the traffic 102, from the downstream base station 140b, and may perform network resource functions prior to transmitting the traffic 102 to the home agent 125 or final destination.

Example embodiments of the present invention can include a quality of service (QoS) classifier table 131, which can be located at a network node, such as gateway 120b. The QoS classifier table 131 can maintain or include information relating to a subscriber or set of subscribers 150a-g on the network 100. The QoS classifier table 131 can be a centrally located repository for individual subscriber parameters that can be used by or forwarded to entities in the network 100 to enforce QoS on a per-subscriber basis.

Alternatively, an example embodiment of the present invention can support scalability of network resources and provide for fast processing on a per-subscriber basis because the embodiment can group subscribers together based on common parameters. The QoS classifier table 131 can map multiple subscribers with common parameters to a single class of service type (not shown), thereby lowering resource requirements on the network elements. In alternative example embodiments, QoS can provide different priorities to different elements of the network, which may include, for example, providing different services based on applications, subscribers, performance level, data flows, or other commonly known or here-after developed elements requiring quality of service specifications. QoS parameters can include, for example, delay, jitter, bit rate, guarantees, bandwidth, or other commonly employed or hereafter-developed parameters useful for quality of service in a network, such as a mobile communications network.

An example embodiment of the present invention includes a subscriber-aware switch, such as switch 119 in FIG. 1, that directs traffic from a subscriber to the specific line card where the subscriber's profile is maintained; for example, the switch can be configured to determine a subscriber profile associated with the communications traffic 102. Details of a subscriber-aware switch are described further in Applicants' pending U.S. patent application (Serial Number not yet assigned) being filed concurrently herewith, entitled “Method and Apparatus for Switching Communications Traffic in a Communications Network” by Santosh Chandrachood and Pawan Uberoy, which claims priority to Applicants' U.S. Provisional Patent Application No. 61/278,496, filed Oct. 7, 2009, entitled “A Method and Apparatus for Subscriber Distribution and Load Balancing Using Mid-Plane Design in a Subscriber Aware Platform Such as ASN Gateway, GGSN, SGSN etc.” by Chandrachood et al., the entire teachings of both applications being incorporated herein by reference in their entirety. The switch 119 is a subscriber-aware switch and has knowledge of the subscriber's profile location, whereas previous switches are non-subscriber-aware switches, for example, such as multiplexer switches, which merely switch traffic without being aware of the traffic's destination.

FIG. 2 is a block diagram 200 of an embodiment of the invention illustrating interconnected functional elements 260a-b, where functional element 260b is designated as an anchor functional element. The functional elements 260a-b are interconnected operably via a fabric 265; alternatively, all functional elements in a chassis may be interconnected via a fabric 265.

When a subscriber enters a network, like the network 100 in FIG. 1, service flows and other configurable attributes, such as quality of service (QoS) parameters, are created or provisioned as per the attributes. A service flow management (SFM) entity at a base station, may be a logical entity that may create, admit, activate, modify, or delete service flows as may be desired or needed. The QoS classifiers may be used to implement service flows, where QoS classifiers may include, for example, congestion avoidance, congestion management (e.g., priority queuing), classification, traffic conditioning (e.g., shaping flows using different rates), marking, or traffic separation.

Example embodiments of the present invention can include a functional element at a gateway node, or other network node, which has access to a network processing unit (NPU). For example, the block diagram 200 illustrates two functional elements 260a-b, which are interconnected by a fabric 264. The functional elements 260a-b can be, for example, line cards around a network node, or multiple line cards in a chassis. The functional element 260a is designated as a local functional element and the functional element 260b is designated as an anchor functional element. The functional element 260a receives the traffic 202, from a downstream base station (not shown), and may perform network resource functions prior to transmitting the traffic 202 to a second functional element 260b. The functional element 260b can be an anchor line card, such that the anchor line card 260b includes information on a subscriber in the network. For example, a subscriber has a subscriber profile (explained in more detail below) at line card 260b, which is thereby designated, optionally by a central processing unit (CPU) 264a, as the anchor line card out of any interconnected line cards because the subscriber's profile is located at that specific line card 260b. However, any line card, which may be physically or logically interconnected, can be designated as an anchor line card for the same subscriber's profile of other subscriber profiles. Further, line cards can be a primary anchor or backup anchor, where backup anchor line cards become primary anchor line cards for a subscriber's profile in an event of a failure of the primary anchor, configuration, or other fault, depending on multiple factors, for example, where a subscriber's profile is located.

Functional element 260a receives subscriber traffic from a network or base station (as illustrated in FIG. 1) via an ingress-interface port 271; the specific ingress-interface port 271 can be determined based on a protocol designated in the traffic packet. Alternatively, the functional element 260a can receive subscriber traffic via a fabric 265 from a different line card (not shown) in a chassis or otherwise interconnected to functional element 260a in a logical or physical configuration. However received, traffic packet 202 may directly enter NPU 263a via a NPU interface (not shown), or, alternatively, the traffic packet 202 may enter a traffic management entity 219a, which may direct the packet further using commonly employed or hereafter-developed methods of traffic management. The NPU 263a can forward the traffic packet directly to the anchor functional element 260b via fabric 265 using information from the CPU 264a, which is configured to know the anchor line card of the subscriber traffic. In alternative embodiments, all CPUs in the network node collectively determine the anchor line card for a given subscriber.

Similar to the functional element 260a, the anchor functional element 260b can receive the traffic packet 202, which can directly enter NPU 263b via a NPU interface (not shown), or, alternatively, the traffic packet 202 may enter a traffic management entity 219b, which may direct the packet further using commonly employed or hereafter-developed methods of traffic management.

The NPU 263b at the anchor functional element 260b can determine, in conjunction with the CPU 264b, classifier table 231, and other optionally interconnected devices, service parameters. For example, in one embodiment, the service parameters can be determined using a service type 255a-c of network traffic 202 that is associated with service profiles, the service parameters can be quality of service (QoS) parameters. Alternatively, in other example embodiments, the service parameters can be determined as a function of the subscriber identifier and the service class identifier. The classifier table 231 can determine rules 256a-c to apply to the traffic 202 based on the service type 255a-c and determine actions 259a-c to apply to the traffic based on the determined rules 256a-c.

For example, another embodiment of the present invention can allow a subscriber on the network to be determined with a certain service profile. The service profile can be contained in a table, such as a QoS profile table 232, which may include the subscriber's service type information 255a-c, the rules 256a-c associated with that type of service, and the actions 259a-c that can be taken based on the rules and services of the subscriber. The service type 255a-c can include, for example, data service 255a, voice service 255b, video stream service 255c, etc., where the voice service 255b has classifiers, or rules 256b, that can allow for different actions 259b to take place.

For example, one rule can state that if the call is an emergency call, mark the first traffic packet received as a high priority packet; therefore, the action may be to send that traffic packet as a high priority packet. Any additional packets determined to have the same protocol address, such as a wide area network (WAN) protocol address, as the first packet, are similarly marked with the subscriber identifier of the first packet.

Additional example embodiments of the present invention can include a module at a network node, which has access to a NPU, which can determine service parameters using a service type of network traffic that is associated with service profiles, the service parameters can be QoS parameters. The module can be in ay configuration, may include one or more corresponding or interconnected modules, in a system of any physical or logical configuration.

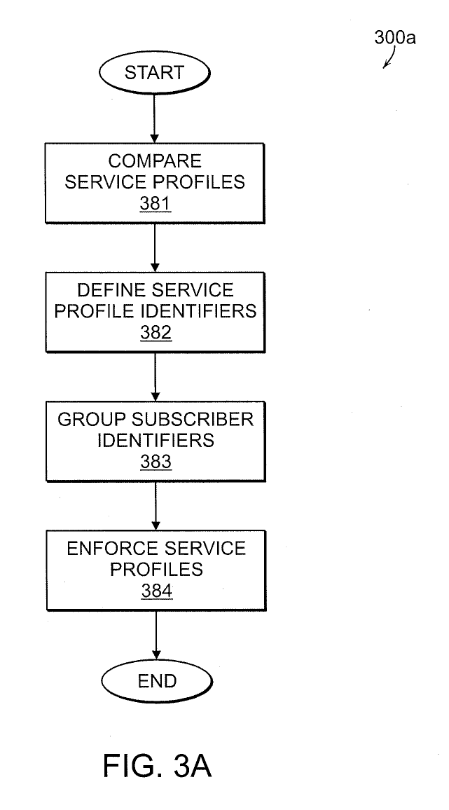

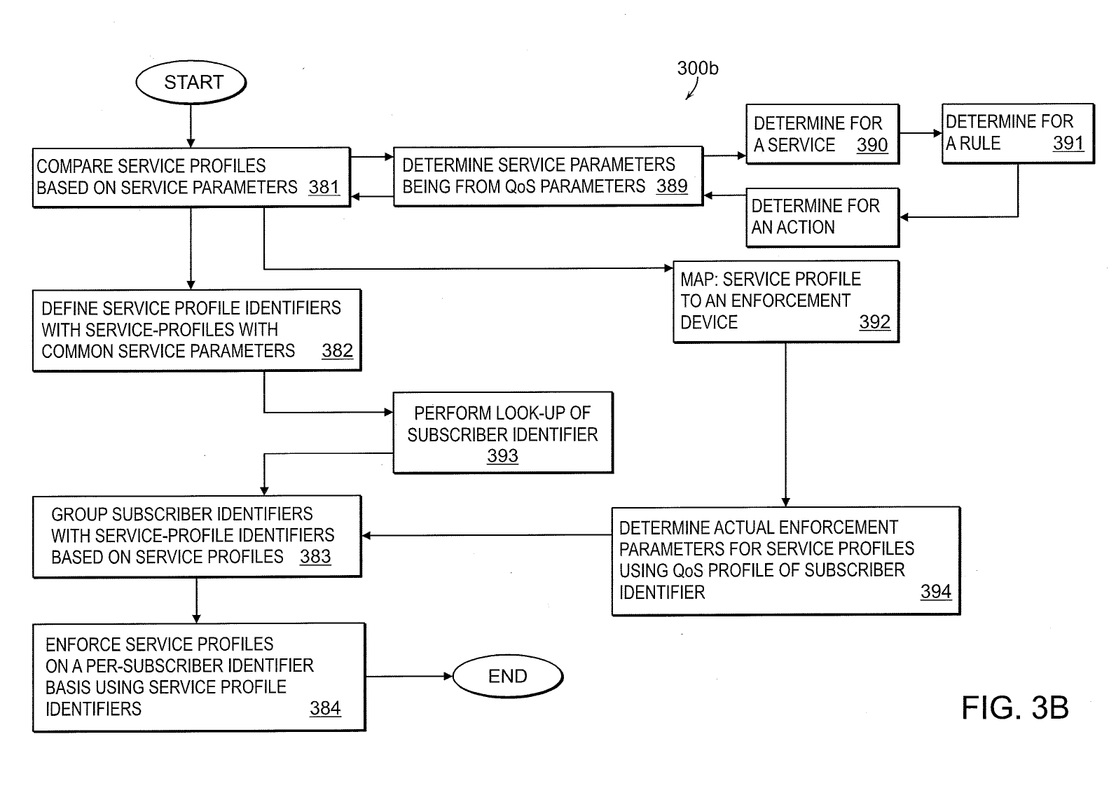

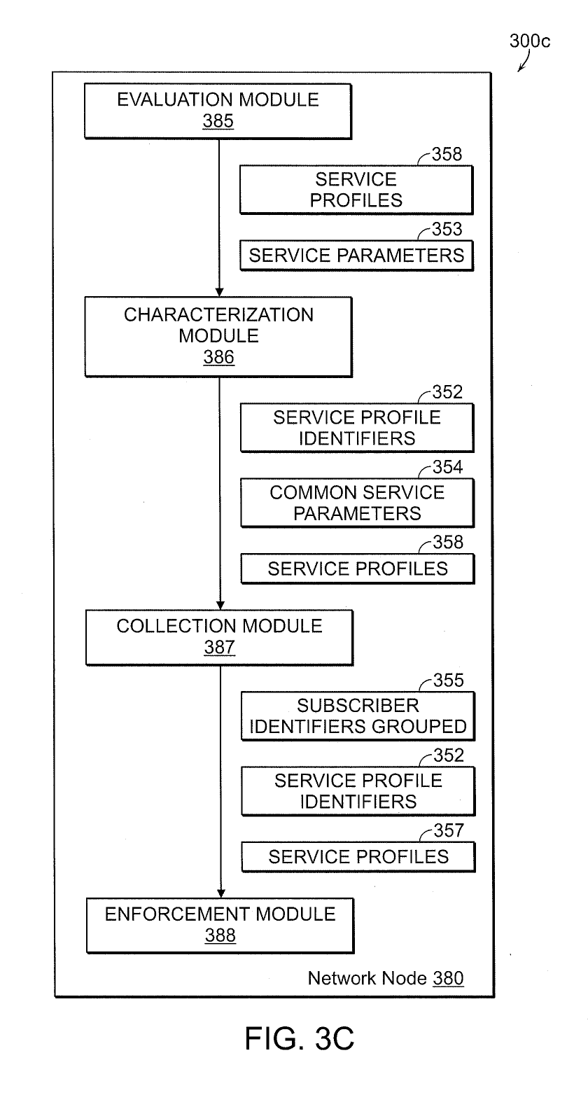

FIG. 3A is a flow chart 300a illustrating a method by which a line card, such as the line card 260b of FIG. 2, can enforce service profiles according to an example embodiment of the present invention. According to the example embodiment, the flow chart 300a compares service profiles of subscribers in a network, such as the network 100 of FIG. 1, based on service parameters associated with the service profiles (381). The line card then defines service-profile identifiers for service profiles that have the same or common service parameters (382). The line card may create groups of subscribers, based on the subscriber identifiers associated with each subscriber, where creating a group can include grouping subscriber identifiers with service-profile identifiers based on the service profiles (383). Further, the line card may use the service profile identifiers to enforce service profiles on a per-subscriber basis (384).

Alternative example embodiments can allow for identifying new subscribers joining the mobile network that may need a new service-profile identifier and generating one in a dynamic manner for that new subscriber. If the subscriber is not a new subscriber, in other words, the subscriber is associated with an existing subscriber identifier, it is determined whether that subscriber identifier is associated with a service-profile identifier, if not associated, a service-profile identifier having common service parameters as the subscriber identifier is generated in a dynamic manner and associated with the subscriber identifier.

FIG. 3B is a flow diagram 300b illustrating a method by which a network node, such as the gateway node 120b in FIG. 1, can enforce service profiles according to an embodiment of the present invention. According to the example embodiment, the flow diagram 300b compares service profiles based on service parameters (381), where the service parameters can be determined using quality of service (QoS) parameters (389). QoS parameters may include services, rules, and actions for a specific subscriber or group of subscribers in a network, such as network 100 in FIG. 1; the QoS parameters can be determined by determining a service type associated with a service profile (390), then determining the rules associated with the service type (391), and then determining actions that can be taken or applied to traffic in the network based on the rules (392). The flow diagram 300b can compare service profiles based on service parameters (381). Based on the determined service parameters or QoS parameters, service-profile identifiers are defined with service profiles (382); the service profiles can then be mapped to an enforcement device, such as a memory (393). Alternatively, service profiles or additional information may be mapped to the enforcement device at any time.

Continuing to refer to FIG. 3B, the flow diagram 300b performs a look-up of subscriber identifiers of the subscribers in the network, such that each subscriber can have a unique subscriber identifier (394). Following determination of subscriber identifiers, the example embodiment groups subscriber identifiers, based on service profiles, to service-profile identifiers (383). The flow diagram 300b can combine multiple subscriber identifiers with common parameters, which can be grouped as service-profile identifiers. The grouped service-profile identifiers can enhance efficient use of network resources by having fewer identifiers than subscribers in the network because the subscriber identifiers can be grouped. Details of which are described in Applicants' pending U.S. patent application (Serial Number not yet assigned) being filed concurrently herewith, entitled “Method and Apparatus to Report Resource Values in a Mobile Network” by Santosh Chandrachood and Henry Fung, which claims priority to Applicants' U.S. Provisional Patent Application No. 61/278,520, filed Oct. 7, 2009, entitled “A Method and Apparatus to Read Large Hardware Counters in a Scalable Way” by Chandrachood et al., the entire teachings of both applications being incorporated herein by reference in their entirety. The example embodiment of the flow diagram 300b determines actual enforcement parameters, such as determining the actual service type, maximum rate, queuing parameters, statistics, or policy enforcement procedures for the subscriber identifier. In some embodiments, the service profiles are enforced on a per-subscriber-identifier basis using the profile identifiers (384).

Alternative embodiments of the present invention may include additional QoS parameters, where the QoS parameters are specified for different layers of a system. QoS parameters can include, for example, expected performance characteristics, degree of synchronization between related services, events, rules, actions, or information flows, degree of resource commitment, cost of service, service access point specifications, and other commonly known or hereafter-developed requirements.

Alternative embodiments may allow for actual enforcement parameters to be bearer dependent, include traffic scheduling information, ordering, queuing, or other commonly employed or hereafter-developed procedures for enforcing quality of service or service parameters.

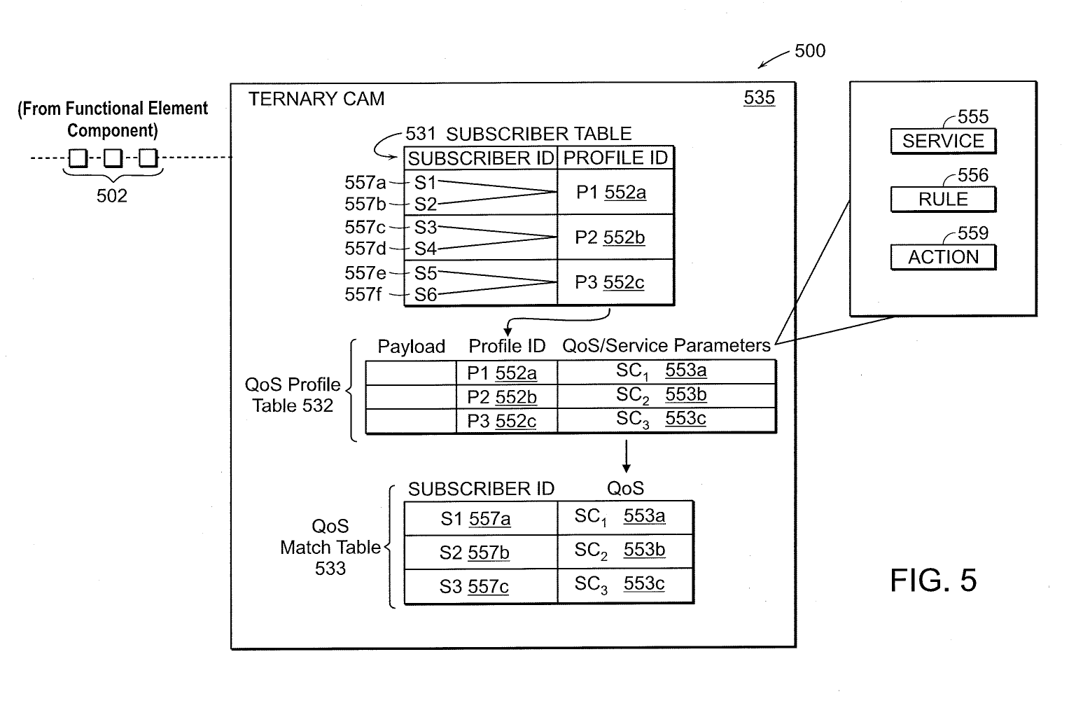

FIG. 3C is a block diagram 300c illustrating a network node 380 according to an example embodiment of the present invention. Components of the network node 380 can include an evaluation module 385, characterization module 386, collection module 387, and enforcement module 388. According to the example embodiment, the evaluation module 385 compares multiple service profiles 358 based on service parameters 353 corresponding with the service profiles 358. The evaluation module 385 can forward a copy of information, such as the service profiles 358 and the service parameters 353, to the characterization module 386. The characterization module 386 can define service-profile identifiers 352 based on the service profiles 358 that have common service parameters 353. The collection module 387 is configured such that it can receive information from the characterization module 386, may include, for example, the service profiles 358, the service parameters 353, and the service-profile identifiers 352; alternatively, the collection module 387 can receive service-profile identifiers 352 and service profiles 358. The collection module 387 can group subscriber identifiers (described in more detail in reference to FIG. 5) with the service-profile identifiers 352 based on the service profiles 358. The enforcement module 388 can enforce service profiles 358 on a per-subscriber-identifier basis using the service-profile identifiers 352.

In alternative embodiments, any or all of the modules 385-388 may exist on a functional element at a network node or as individual, interconnected modules located at different sites on a network, such as network 100 in FIG. 1.

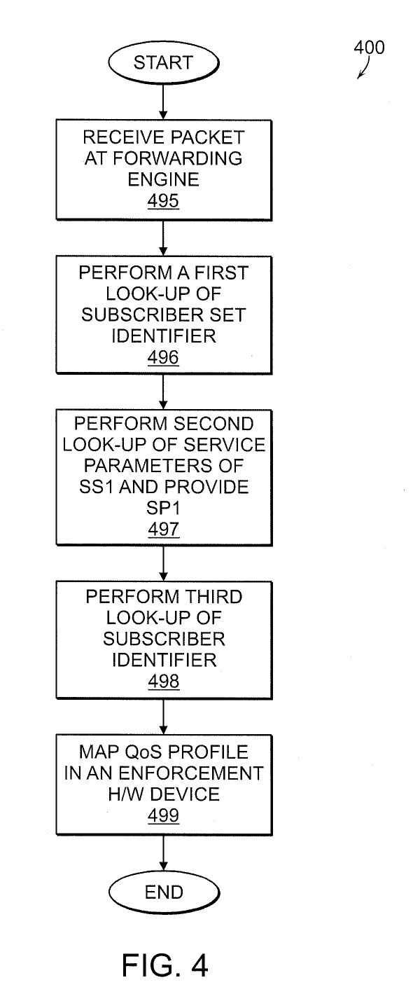

FIG. 4 is a flow chart 400 illustrating a unit in a line card, such as the NPU 263b of FIG. 2 can map quality of service profiles in an enforcement device, where, for example, the enforcement device is a memory. Additional embodiments of the present invention allow for a memory to store service-profile identifiers or map the service profiles such that the information is accessible to the NPU. For example, following receipt of a packet at a module (495), a second module performs multiple table look-ups in order to map a service profile, where the service profile is based on unique QoS parameters. First, the service-profile identifier is looked-up in a hardware device (496); second, the service parameters are looked-up based on the information determined from the first look-up (497); last, the subscriber identifier is determined (498), which can be a dynamically determined identifier associated with a single user, associated with the determined service-profile identifiers can be retrieved and mapped in the memory (499). Based on a combination of any of the determined information, a service profile is enforced using enforcement parameters based on the unique QoS classifiers of the subscriber identifier.

Alternative embodiments of the present invention can map QoS information, or other information regarding a subscriber in a network, to a table or module in any configuration or format, where such modules can be in a system of any physical or logical configuration.

FIG. 5 is a logical diagram of a memory 500. The memory 500 can be any memory, for example, a ternary content addressable memory (TCAM) 535, which can be used as an enforcement device. TCAM memory is particularly suitable for the described application because other forms of memory may also be employed. The TCAM 535 may include information and data necessary to provide efficient resource allocation of the quality of service (QoS) profiles, such as a subscriber table 531, which can maintain individual subscriber identifiers 557a-f, and the profile identifiers 552a-c corresponding with the individual subscriber identifiers 557a-f. For example, a subscriber entering the mobile network is assigned and provisioned a specific subscriber identifier; such that a first subscriber is assigned subscriber identifier “S1” 557a, which is associated with profile identifier “P1” 552a.

The subscriber table 531 can forward a copy of the profile identifiers 552a-c to a secondary table, a QoS profile table 532, which can include payload of traffic 502 corresponding with the profile identifiers 552a-c and further corresponding to QoS and service parameters 553a-c. QoS parameters may include information regarding a set or sets of services 555, which can correspond to a set or sets of rules 556, which further can correspond to a set or sets of actions 559. For example, the profile identifier “P1” 552a corresponds to QoS parameters, for example, service class 1 (SC1) 553a. The service class 553a may contain a multitude of information, which may include, for example, the service 555, rule 556, or action 559 that correspond to the profile identifier 552a.

The QoS profile table 532 may forward the QoS information or a copy of the service class 553a-c information to a tertiary table, a QoS match table 533, which can include, for example, the subscriber identifiers 557a-c and the QoS service classifiers that correspond to the individual subscriber identifiers 557a-c.

Alternative embodiments of the present invention can include, for example, multiple types of memory interconnected or available to forward and receive data from another memory unit. Other embodiments may include fewer or greater numbers of tables with similar or different network information.

Further example embodiments of the present invention may include a non-transitory computer readable medium containing instruction that may be executed by a processor, and, when executed, cause the processor to monitor the information, such as components or status, of at least a first and second network element. It should be understood that elements of the block and flow diagrams described herein may be implemented in software, hardware, firmware, or other similar medium determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read only memory (CD-ROM), and so forth. In operation, a general purpose or application specific processor loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments of the invention.

The teachings of all patents, published applications, and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method of enforcing service profiles in a mobile network, the method comprising:
comparing multiple service profiles based on multiple service parameters of the service profiles;
defining multiple service-profile identifiers with multiple service profiles having common service parameters;
grouping subscriber identifiers with the respective service-profile identifiers based on multiple service profiles; and
enforcing service profiles on a per-subscriber identifier basis as a function of the service profile identifiers.

2. The method of claim 1 wherein multiple service parameters are quality of service (QoS) parameters and further comprising determining multiple service parameters by:
determining a service type of traffic associated with the service profile;
based on the service type, determining a rule to apply to the traffic; and
based on the rule, determining an action to apply to the traffic.

3. The method of claim 1 further comprising:
distributing a subscriber identifier Internet protocol address for a first subscriber identifier; and
for subsequent subscriber identifiers grouped to the same service-profile identifier, distributing the respective service-profile identifiers.

4. The method of claim 1 further comprising, upon identifying a new subscriber identifier associated with a subscriber's device joining the mobile network, dynamically generating at least one of multiple service profiles having a service-profile identifier.

5. The method of claim 4 further comprising:
detecting a subsequent subscriber identifier, other than a new subscriber identifier;
determining the subscriber identifier for at least one of multiple respective service-profile identifiers; and
assigning the subscriber identifier to service-profile identifiers, the service-profile identifiers containing subscriber identifiers having common service profiles.

6. The method of claim 5 further comprising:
mapping service profiles within an enforcement device to at least one of the common service profiles; and
based on the mapping, enforcing at least one of the common service profiles.

7. The method of claim 5 further including storing the service-profile identifiers, each of the service-profile identifiers having a unique set of QoS classifiers.

8. The method of claim 5 further including, following receipt of a packet, performing:
(i) a first look-up of the service-profile identifiers associated with a packet to launch a look-up of rules in a database;
(ii) a second look-up of the rules or service parameters to determine a service class identifier;
(iii) a third look-up of actual subscriber-identifier parameters on a per-subscriber identifier and per-service class identifier basis; and
(vi) mapping the unique QoS profile.

9. The method of claim 8 further comprising determining enforcement parameters for multiple service profiles in the mobile network as a function of the unique QoS profile of the subscriber identifier.

10. The method of claim 1 further comprising performing a look-up based on the subscriber identifier to determine the service-profile identifier for the subscriber identifier, the service profile identifier matching multiple service parameters, the service parameters including functional effects including services, rules, or actions, or combinations thereof.

11. A network node in a mobile network for enforcing service profiles, the network node comprising:
an evaluation module configured to compare multiple service profiles based on multiple service parameters of multiple service profiles;
a characterization module configured to define multiple respective service-profile identifiers with multiple service profiles having common service parameters;
a collection module configured to group subscriber identifiers with the respective service-profile identifiers based on multiple service profiles; and
an enforcement module configured to enforce service profiles on a per-subscriber-identifier basis as a function of the respective service-profile identifiers.

12. The network node of claim 11 further comprising a classification module, accessible to a network processing unit (NPU), including a classification table containing at least multiple service parameters, the multiple service parameters being quality of service (QoS) parameters.

13. The network node of claim 12 wherein the classification module is further configured:
to determine multiple service parameters as a function of a service type of traffic associated with the service profiles;
based on the service type, to determine a rule to apply to the traffic; and
based on the rule, to determine an action to apply to the traffic.

14. The network node of claim 11 further comprising a determination module coupled to the collection module and configured to determine the subscriber identifier for a first traffic packet's wide-area-network (WAN) protocol address, and wherein for subsequent traffic packets having the same WAN protocol address, the determination module is configured to use the subscriber identifier determined for the first packet.

15. The network node of claim 11 wherein the characterization module is further configured to generate a service-profile identifier in a dynamic manner following identifying a new subscriber is joining the mobile network.

16. The network node of claim 11 wherein the characterization module is further configured to:
detect a subsequent subscriber identifier, other than a new subscriber identifier;
determine whether the subsequent subscriber identifier has service parameters in common with other subscriber identifiers; and
if so, assign the subsequent subscriber identifier to a service-profile identifier, the service-profile identifiers having common service parameters, if not, generate a service-profile identifier in a dynamic manner.

17. The network node of claim 11 further comprising an enforcement device, accessible to a network processing unit (NPU), configured to map the service profiles.

18. The network node of claim 11 further comprising a memory, accessible to a at least one of the evaluation module, characterization module, collection module, implementation module, and the memory configured to store the service-profile identifiers, each service-profile identifiers having a unique set of QoS classifiers.

19. The network node of claim 18 wherein the memory is a ternary content addressable memory.

20. The network node of claim 18 wherein, following receipt of a packet at a forwarding engine, the characterization module is still further configured to map a unique QoS profile by performing, in hardware:
a first look-up of the service-profile identifiers associated with a packet to launch a look-up of rules in a database;
a second look-up of the rules or service parameters to determine a service class identifier; and
a third look-up of actual subscriber-identifier parameters on a per-subscriber identifier and per-service class identifier basis.

21. The network node of claim 20 wherein the implementation module is further configured to determine.
enforcement parameters, for multiple service profiles, based on the unique QoS classifiers of the subscriber identifier; and
enforcing at least one of the common service profiles.

22. A computer program product including a computer readable medium having computer readable instructions to enforce service profiles in a mobile network, wherein the computer readable instructions when executed by a processor, cause the processor to:
compare multiple service profiles based on multiple service parameters of the service profiles;
determine multiple respective service-profile identifiers with multiple service profiles having common service parameters;
group subscriber identifiers with the service-profile identifiers based on multiple service profiles; and
enforce service profiles on a per-subscriber-identifier basis as a function of the service profile identifiers.
